(19) United States
(12) Patent Application Publication
(10) Pub. No.: US 2025/0111406 A1
(43) Pub. Date: Apr. 3, 2025

(54) TELECOMMUNICATIONS USER EXPERIENCE MODELING

(71) Applicant: T-Mobile USA, Inc., Bellevue, WA (US)

(72) Inventors: Qianwen Wen, Herndon, VA (US); Jim Joojin Song, Atlanta, GA (US)

(21) Appl. No.: 18/480,265

(22) Filed: Oct. 3, 2023

(51) Int. Cl. G06Q 30/0242; G06Q 30/0251

(52) U.S. Cl. CPC G06Q 30/0245; G06Q 30/0257; G06Q 30/0267

(57) ABSTRACT

Described herein is a system for using a machine learning model to predict a metric value indicative of quality of user experience. The system can receive an indication that a mobile device was used to access electronic content. The system obtains a set of characteristics of a user of the mobile device and generates a predicted metric value indicative of a quality of user experience interacting with the electronic content by applying a trained machine learning model to the obtained set of characteristics. The machine learning model is trained on cluster data representing clusters of users of the system, and each cluster is associated with a one or more shared characteristics of users in the cluster and an average metric value selected by users in the cluster. The system selects and transmit an interactive element associated with the predicted metric value to the mobile device.

### BACKGROUND

Path analysis is a portrayal of a chain of consecutive events that a given user or cohort performs during a set period of time while using a website, online game, or ecommerce platform. As a subset of behavioral analytics, path analysis is a way to understand user behavior in order to gain actionable insights into the data. Path analysis provides a visual portrayal of every event a user or cohort performs as a part of a path during a set period of time. While it is possible to track a user's path through the site, and even show that path as a visual representation, the real question is how to gain these actionable insights for these user experiences.

One way of gaining understanding into user experiences is by eliciting net promoter scores. A net promoter score (NPS) is a market research metric that is based on a single survey question asking respondents to rate the likelihood that they would recommend content (or a company, product, or a service) to a friend or colleague. The NPS assumes a subdivision of respondents into “promoters” who provide ratings of 9 or 10, “passives” who provide ratings of 7 or 8, and “detractors” who provide ratings of 6 or lower. The NPS results from a calculation that involves subtracting the percentage of detractors from the percentage of promoters collected by the survey item. The result of the calculation is typically expressed as an integer rather than a percentage. The core “How likely would you be to recommend . . . ” question is almost always accompanied by an open-ended “Why?” and sometimes by so-called “driver” questions. However, users often do not answer these driver questions or do not provide enough information about who they are and why they provided the NPS that they did to meaningfully update the content with user experience in mind. Additionally, because the NPSs are typically received after a user has finished interacting with content, the content cannot be altered to improve the user experience during their interactions.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a system that can predict metric values representative of user experience quality.

FIG. 3 is a block diagram of using and training a prediction model according to some implementations of the present technology.

FIG. 4 is a flow diagram illustrating a process for transmitting an interactive element based on a predicted metric value.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

An individual may interact with a set of electronic content and provide a net promoter score (NPS) after their interaction to indicate a quality of their experience with the electronic content. Based on NPSs submitted by a plurality of users, an owner of the electronic content can determine whether the average user is a “promoter” with an average NPS of 9 or 10, “passive” with an average NPS of 7 or 8, or “detractor” with an average NPS of 6 or lower and alter the electronic content accordingly with an aim to improve or maintain the average NPS score.

Though NPSs help quantify users' experiences with electronic content, NPSs alone do not offer further insight into how to alter the electronic content to improve user experiences to lead to higher NPSs. For instance, users may have different preferences when it comes to how they interact with the electronic content. For example, a 70-year-old user may more easily navigate (and thus have a better experience with) electronic content that includes a limited number of interactive elements shown in a large size, whereas a 15-year-old user may find electronic content structured in the same way to be too simple and not engaging, resulting in their choosing of a low NPS. Without a way to predict what elements in electronic content lead to promoter NPSs from different users, the owner of the electronic content may alter the electronic content in a way that that changes the path of actions that users perform with the electronic content upon interaction. These changes may result in higher NPS scores from one subset of users while causing users in a different subset to provide lower NPSs than they were previously. Thus, though the owner wanted to increase NPS across the board by creating a “happy path” through the electronic content, some users may be dissatisfied with these changes, resulting in lower NPSs.

Described herein are systems and methods for using machine learning model to predict metric value of a user's experience with electronic content. For example, a user may use their mobile device to interact with electronic content, such as a webpage or website. A system can receive an indication from the mobile device that the user accessed the electronic content and obtain characteristics of the user stored at the system or on the mobile device. The system can generate a predicted metric value indicative of a predicted quality of the user's experience with the electronic content by inputting the characteristics to a machine learning model. The system can determine an interactive element to transmit to the mobile device with the aim to improve or maintain the user's experience with the electronic content based on the predicted metric value.

The machine learning model may be trained on cluster data representing clusters of users of the system. For example, the system can use a clustering algorithm to cluster identifiers of users with shared characteristics, shared actions taken with respect to the electronic content and/or similar dates of interaction. The resulting clusters may each be associated with one or more shared characteristics of users represented by identifiers in the cluster and an average metric value received from those users upon interaction with the electronic content (or other content related to the electronic content). Training the machine learning model in this manner allows the machine learning model to learn what actions users with similar characteristics have taken that lead to each level of NPS score, which the system can leverage to improve a user's experience with the electronic content.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

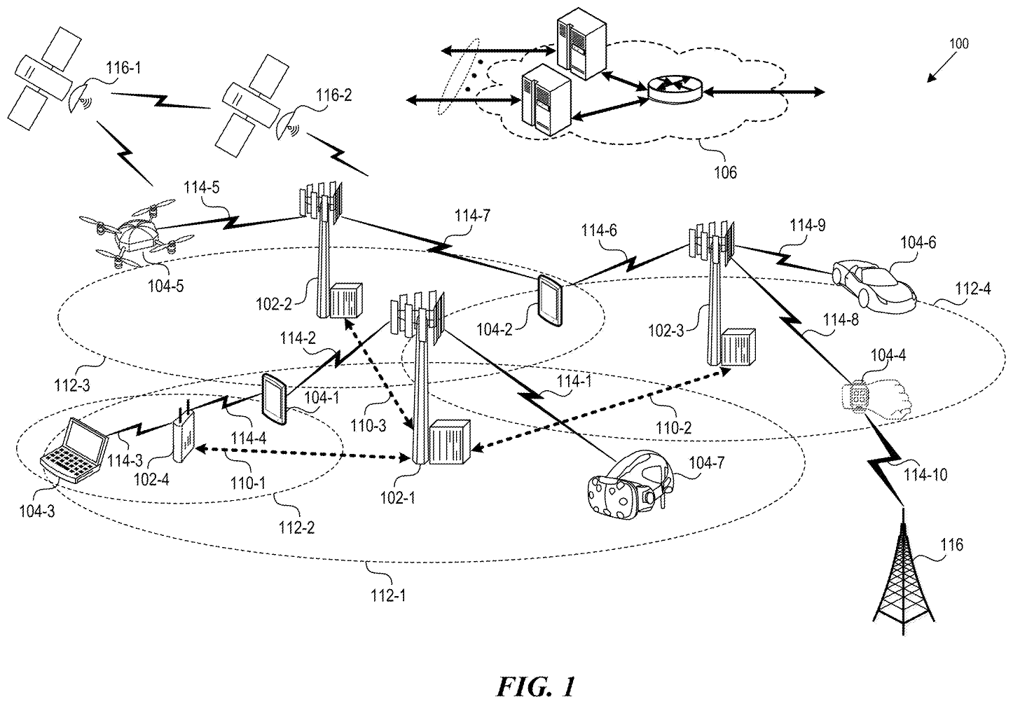

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### User Experience Modeling

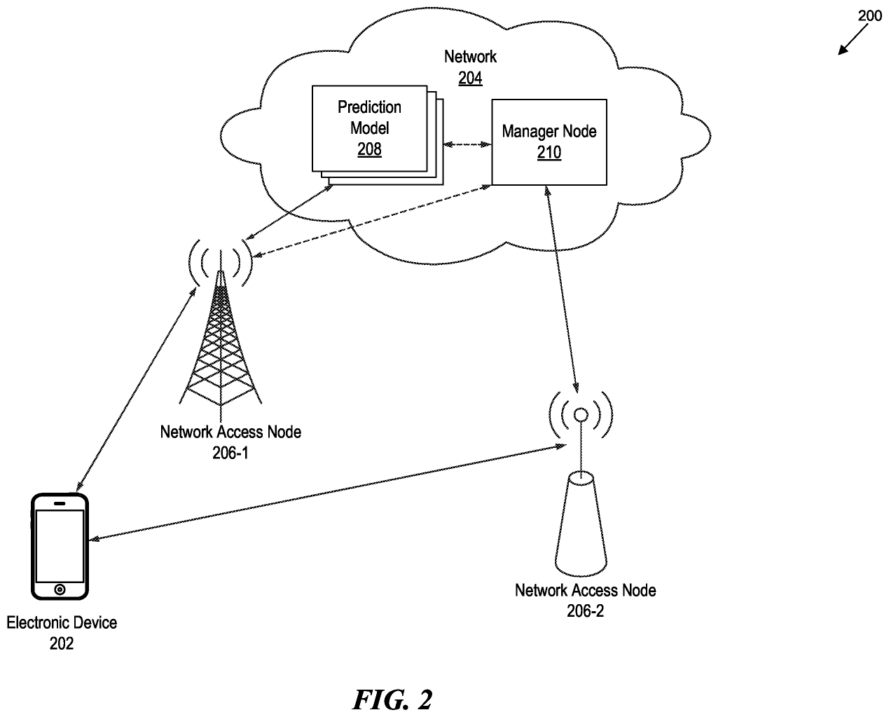

FIG. 2 is a block diagram that illustrates a system that can predict metric values representative of user experience quality. The environment 200 includes an electronic device 202 that is communicatively coupled to one or more networks 204 via network access nodes 206-1 and 206-2 (referred to collectively as network access nodes 206).

The electronic device 202 (which may be wireless device 104 from FIG. 1) is any type of electronic device that can communicate wirelessly with a network node and/or with another electronic device in a cellular, computer, and/or mobile communications system. Examples of the electronic device 202 includes smartphones (e.g., Apple iPhone, Samsung Galaxy), tablet computers (e.g., Apple iPad, Samsung Note, Amazon Fire, Microsoft Surface), wireless devices capable of M2M communication, wearable electronic devices, movable IoT devices, and any other handheld device that is capable of accessing the network(s) 204. Although only one electronic device 202 is illustrated in FIG. 2, the disclosed embodiments can include any number of electronic devices.

The electronic device 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 202 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more buses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 206 can be any type of radio network node that can communicate with a wireless device (e.g., electronic device 202) and/or with another network node. The network access nodes 206 can be a network device or apparatus. Examples of network access nodes include a base station (e.g., network access node 206-1), an access point (e.g., network access node 206-2), or any other type of network node such as a network controller, radio network controller (RNC), base station controller (BSC), a relay, transmission points, and the like.

FIG. 2 depicts different types of network access nodes 206 to illustrate that the electronic device 202 can access different types of networks through different types of network access nodes. For example, a base station (e.g., the network access node 206-1) can provide access to a cellular telecommunications system of the network(s) 204. An access point (e.g., the network access node 206-2) is a transceiver that provides access to a computer system of the network(s) 204.

The network(s) 204 can include any combination of private, public, wired, or wireless systems such as a cellular network, a computer network, the Internet, and the like. Any data communicated over the network(s) 204 can be encrypted or unencrypted at various locations or along different portions of the networks. Examples of wireless systems include Wideband Code Division Multiple Access (WCDMA), High Speed Packet Access (HSPA), Wi-Fi, WLAN, Global System for Mobile Communications (GSM), GSM Enhanced Data Rates for Global Evolution (EDGE) Radio Access Network (GERAN), 4G or 5G wireless WWAN, and other systems that can also benefit from exploiting the scope of this disclosure.

The environment 200 includes a manager node 210 that can facilitate interactions with the electronic device 202 and use of a prediction model 208. In some instances, the manager node 210 establishes communication between the electronic device 202 and prediction model 208 such that the electronic device 202 can directly send inputs to and receive outputs from the prediction module 208. However, for simplicity, the manager node 210 is described herein as acting as an intermediary for data exchange with the electronic 202 for using the prediction model 208.

In some instances, the manager node 210 can include any number of server computers communicatively coupled to the electronic device 202 and/or prediction model 208 via the network access nodes 206. The manager node 210 can include combinations of hardware and/or software to process condition data, perform functions, communicate over the network(s) 204, etc. For example, server computers of the manager node 210 can include a processor, memory or storage, a transceiver, a display, operating system and application software, and the like. Other components, hardware, and/or software included in the environment 200 that are well known to persons skilled in the art are not shown or discussed herein for brevity. Moreover, although shown as being included in the network(s) 204, the manager node 210 can be located anywhere in the environment 200 to implement the disclosed technology.

The manager node 210 can receive requests from the electronic device 202 to access one or more electronic content. An electronic content can be a webpage, website, social media platform, image data, an electronic application, and the like. In some instances, an electronic content can include webpages of a website published by a server of a telecommunications network that employs the manager node 210. The manager node 210 can begin a user session for the electronic device 202, where the user session is indicative of the manager node 210 receiving indications of actions performed at the electronic device 202 with respect to the accessed electronic content (henceforth referred to as singular electronic content for simplicity). Actions can include navigating within the electronic content (e.g., scrolling, swiping, etc.) or to other electronic content (e.g., navigating to a new webpage) and interacting with interactive elements presented at the electronic device 202 as part of the electronic content (e.g., clicking a button, moving a sliding element, etc.). Each interactive element can be associated with a sub-action that takes place upon interaction. For example, user can access a link upon pressing a button associated with the link. The manager node 210 can store indications describing the actions and sub-actions in association with an identifier of the user in a local datastore.

The manager node 210 can obtain a set of characteristics of the user of the electronic device 202. The manager node 210 may access the characteristics as stored in the local datastore with respect to the user's identifier or may access the characteristics from the electronic device 202 itself, provided the user has set the permissions on the electronic device 202 to allow such data access. Characteristics can include age, gender, census region, state, ethnicity, income level, employment status, family status, and the like. These characteristics may have been stored when the user provided account information associated with a telecommunications network of the manager node 210 or can be retrieved from a third-party system, such as a social media platform the user has a profile on. Characteristics can also include a type of the electronic device 202 (e.g., Apple iPhone, Samsung Galaxy), a type of electronic device 202 the user has used to interact with the manager node 210 previously (e.g., a laptop or tablet separate from the electronic device 202 the manager node 210 is receiving indications from), a handset manufacturer of the electronic device 202, internet speed at the electronic device 202 during interaction with the electronic content, internet technology used by the electronic device 202, the user's mobile plan, and the user's data plan. These characteristics may be retrieved by querying the electronic device 202 for their values or can be retrieved from a third-party system.

The manager node 210 can input the set of characteristics of the user to the prediction model 208 to receive a predicted metric score. In some instances, the manager node 210 inputs one or more actions the user has taken with respect to the electronic content along with the characteristics. The predicted metric score may represent the NPS the prediction model 208 forecasts the user of the electronic device 202 would select based on the set of characteristics. The prediction model 208 is a machine learning model trained to predict a metric value, such as an NPS, that the user may select after their interaction with the electronic content based on their characteristics. In some instances, the prediction model 208 is further trained to output a suggested action for the user to take with respect to the content. The prediction model 208 can be a decision tree, support vector machine, regression model, Bayesian network, Gaussian process, genetic algorithm, or artificial neural network (or, simply, neural network). Examples of neural networks include Feedforward Neural Networks, convolutional neural networks (CNNs), Recurrent Neural Networks (RNNs), Autoencoder, and Generative Adversarial Networks (GANs). The prediction model 208 can include a number of structure layers and a number of nodes (or neurons) at each structure layer. Each node can be associated with an activation function that defines how to node converts data received to data output. The structure layers may include an input layer of nodes that receive input data (e.g., the characteristics) and an output layer of nodes that produce output data (e.g., the predicted metric value). The prediction model 208 may include one or more hidden layers of nodes between the input and output layers.

The prediction model 208 can be associated with model parameters that represent relationships between characteristics and metric values learned during training and can be used to generate the predicted metric value. The model parameters can weight and bias the nodes and connections of the prediction model 208. For instance, when the prediction model 208 is a neural network, the model parameters 322 can weight and bias the nodes in each layer of the neural networks, such that the weights determine the strength of the nodes and the biases determine the thresholds for the activation functions of each node. The model parameters, in conjunction with the activation functions of the nodes, determine how the input data is transformed into output data. The model parameters can be determined and/or altered during training of the prediction model 208.

The manager node 210 can create training data for training the prediction model 208. The manager node 210 can access the local storage to retrieve experience data of users who previously accessed the electronic content (or other content related electronic content). The experience data can include identifiers of the users, their associated characteristics, and a metric value the user selected to represent the quality of their experience interacting with the electronic content. In some instances, the manager node 210 may access characteristics of users identified in the experience data from their electronic devices or a third-party system, provided the users are further associated with privacy settings that allow for such data access. The experience data can also include one or more actions performed at a respective user's electronic device during the respective user's user session with the electronic content. In some instances, the actions may be ordered in a sequence based on when they were performed. The experience data can further include a month or date that the user interacted with the electronic content.

The manager node 210 can input the experience data and associated user identifiers to a clustering algorithm that employs one or more clustering techniques create clusters based on the experience data. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the clustering algorithm may be trained to be a k-means clustering algorithm, which partitions n observations in k clusters such that each observation belongs to the cluster with the nearest mean serving as a prototype of the cluster. The clustering algorithm creates clusters of user identifiers that have one or more of the same characteristics, are associated with one or more of the same actions, and/or interacted with the electronic content or a telecommunications network associated with the manager node 210 in a similar season/time of year based on the experience data.

The clustering algorithm can cluster the user identifiers such that variance of characteristics between the clusters is minimized, wherein each cluster is associated with a set of shared characteristics of users in the cluster. In some instances, the clustering algorithm also uses experience data describing actions taken by the users with the content to create the clusters. For example, the clustering algorithm may create a cluster of users that are all women living in Texas that interacted with the content for at least 5 minutes before selecting a particular button embedded in the content. The manager node 210 labels each cluster with an average (or median, nearest whole number to the average, etc.) metric value indicated by users associated with the cluster and shared characteristics and/or shared actions related to user identifiers of the cluster and stores the labeled clusters as training data in the local datastore. In some instances, the manager node 210 sends the labeled clusters to an external operator for verification of the labeling, and the external operator can return the labeled clusters with changes in the labeling based on their review.

The manager node 210 can input the clusters to the prediction model 208 for training. The manager node can determine a loss function, which is a metric used to evaluate the prediction model's performance during training. For instance, the manager node 210 can measure the difference between a predicted output of the prediction model 208 and the actual output of the prediction model 208 and guide optimization of the prediction model 208 during training to minimize the loss function. The loss function may be presented to an external operator, such that the external operator can determine whether to retrain or otherwise alter the prediction model 208 if the loss function is over a threshold. In some instances, the prediction model 208 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The manager node 210 can adjust the model parameters to minimize the loss function during training of the prediction model 208. In other words, the manager node 210 can use the loss function as a guide to determine what model parameters lead to the most accurate prediction model 208. The manager node 210 can employ an optimizer for determining the model parameters. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer used may be determined based on the type of machine learning model the prediction model 208 is and the size of the experience data being clustered.

The manager node 210 can execute regularization operations for training the prediction model 208. Regularization is a technique that prevents over- and under-fitting of the prediction model 208. Overfitting occurs when the prediction model 208 is overly complex and too adapted to the training data, which can result in poor performance of the prediction model 208. Underfitting occurs when the prediction model 208 is unable to recognize even basic patterns from the training data such that it cannot perform well on training data or on validation data. The manager node 210 can apply one or more regularization techniques to fit the prediction model 208 to the training data properly, which helps constrain the resulting trained prediction model 208 and improves its ability for generalized application. Examples of regularization techniques include lasso (L1) regularization, ridge (L2) regularization, and elastic (L1 and L2 regularization).

The manager node 210 can receive predicted metric values from the prediction model 208 based on the input characteristics. The predicted metric value can be indicative of the rating of the quality of their experience interacting with the electronic content that the prediction model 208 expects that the user would pick based on their characteristics and/or one or more actions performed with the electronic content. The manager node 210 can determine an interactive element to display to the user at the electronic device 202 to augment their experience. Examples of interactive elements include buttons, text boxes, drop-down menus, checkboxes, and other visual elements that can be included in the electronic content that cause an action to occur in response to interaction from a user. For example, the manager node 210 may select a button that causes a video to play upon interaction to display to the user to guide the user to watch the video. In some instances, the prediction model 208 can output a suggested action for the user to take along with the predicted metric value, which the manger node 210 uses to select an interactive element. For example, the prediction model 208 may suggest navigating to a related set of electronic content and select a button that causes this to happen upon interaction.

The manager node 210 can access an index of interactive elements each associated with a range of metric values and actions and select an interactive element associated with a range that includes the predicted metric value and/or an interactive element associated with a suggested action output by the prediction model 208. Interactive elements associated with promoter values (e.g., 9 to 10) may be designed or selected to keep the user on a “happy path” navigating through the electronic content, such that the user will still be likely to select a metric value within the range of promoter values at the end of their user session. Interactive elements (also referred to as “corrective interactive elements”) associated with passive values (e.g., 7 to 8) and detractor values (e.g., 6 and below) may be designed or selected to steer the user to a “happier path” in their user session with the aim of increasing the metric value the use does from the predicted metric value. Said another way, the manager node 210 can select interactive elements meant to improve the user's experience interacting with the electronic content in the user session and cause the user to select better or similar metric values at the end of the user session. The manager node 210 can transmit the interactive element to the electronic device 202 for display to the user.

The manager node 210 can prompt the user to select a metric value during or at the end of the user session. For instance, the manager node 210 can transmit for display textual or audio data asking the user to rate the quality of their experience during the user session, how satisfied they are with the electronic content and/or user session, how likely the user is to recommend the electronic content or an associated system (such as a telecommunications network) to a friend or family member, etc. The manager node 210 can transmit interactive elements that the user can interact with to select a metric value representing their answer. For example, the use may select a value between 1 and 10, where 1 indicates that the user is very dissatisfied with their experience and 10 indicates that the user is extremely satisfied with their experience. The manager node 210 stores the selected metric value in the local datastore in association with the user's identifier, the predicted metric value, actions the user took, and other experience data.

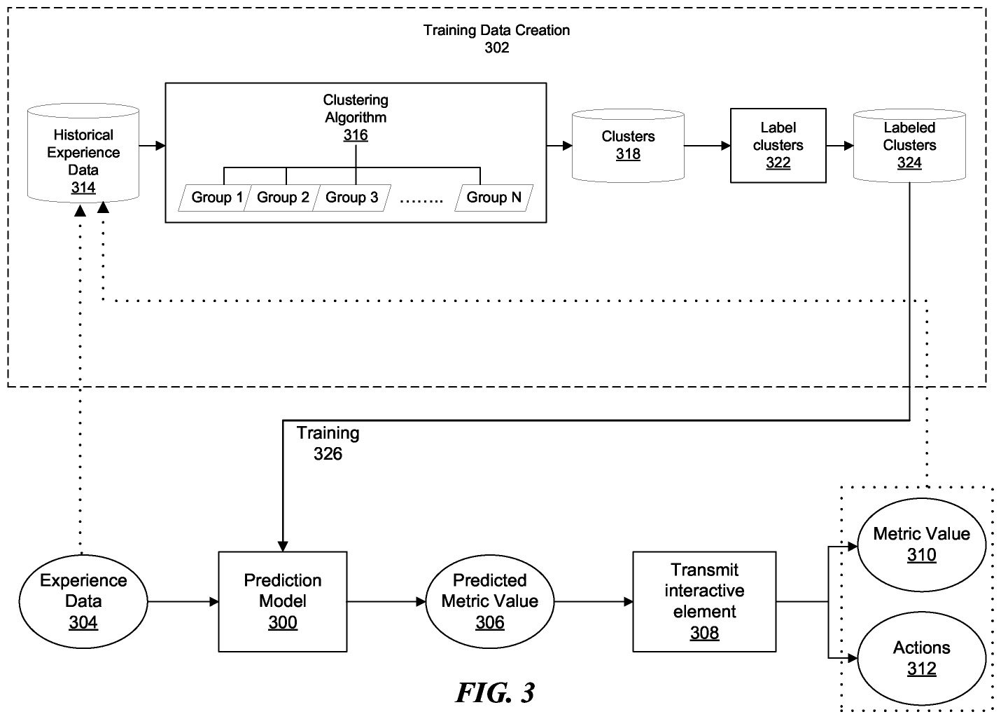

FIG. 3 is a block diagram of using and training the prediction model 300 (or prediction model 208) according to some implementations of the present technology. The prediction model 300 receives experience data 304 of a user interacting with electronic content during a user session from the manager node 210. The experience data may include characteristics of the user, actions the user has already taken with respect to the electronic content, and/or a season/date of the interaction. The prediction model 300 generates a predicted metric value 306, which can represent an NPS that the prediction model 300 forecasts the user would select after the user session. In some embodiments, the predicted metric can represent a variation of an NPS, a customer satisfaction score, a customer effort score, a metric describing user churn, a product engagement score, a customer health score, or a combination thereof.

The prediction model 300 transmits an interactive element 308 to an electronic device 202 of the user, where the interactive element is selected based on the predicted metric value 306 to guide the user through the electronic content to improve or maintain the metric score the user ultimately selects. The manager node 210 receives the selected metric value 310 and actions 312 the user took after transmission of the interaction element 308 and stores the selected metric value 310 and actions 312 and characteristics of the user indicated by the experience data 304 in a local data store.

The manager node 210 creates training data 302 using historical experience data 314 of user who interacted with the electronic content, other content related to the electronic content, or a system associated with the electronic content. The manager node 210 inputs the historical experience data 314 to a clustering algorithm 316 that creates clusters 318 (e.g., group 1, group 2, group 3 . . . group N) of users based on shared historical experience data of users. The manager node labels the clusters 322 with the shared experience data and a metric value representing the metric values historically selected by users in the cluster 318. For example, the manager node 210 may find an average, median, sum, or mode of the historical metric values and label the cluster 318 with the result. The manager node 210 inputs the labeled clusters 324 to the prediction model 30 for training 326. The manager node 210 can retrain the prediction model 300 upon receiving new historical experience data, when requested to do so by an external operator, at set increments of time, and the like.

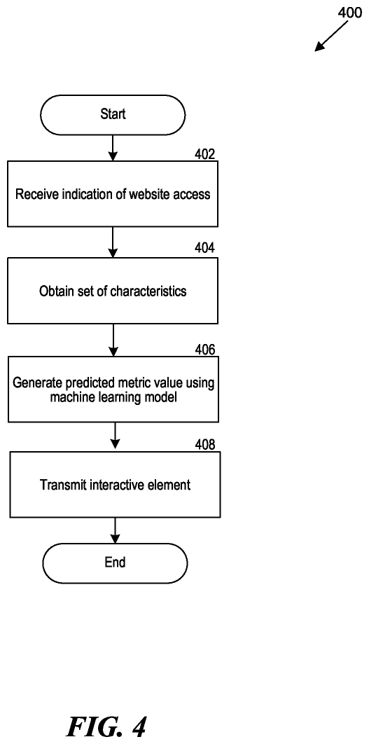

FIG. 4 is a flow diagram illustrating a process 400 for transmitting an interactive element based on a predicted metric value. The process is described in relation to the manager node 210 of FIG. 2, but in some instances, another node, system, or engine may perform the process 400.

At operation 402, the manager node 210 receives, from an electronic device 202, an indication that the electronic device 202 was used to access or otherwise interact with electronic content. In some instances, the electronic content can be associated with a telecommunications network. At operation 404, the manager node 210 obtains a set of characteristics of a user of the electronic device 202. Characteristics can include age range, gender, education level, language, interests, location of residence, daily time spent interacting with the electronic device 202, third-party systems the user has interacted with via the electronic device 202, and the like. In some instances, the manager node 210 receives other experience data with the set of characteristics, such as a sequence of actions the user has taken with respect to the electronic content in the past and a time, date, or season that the indication was received (metric values selected by users can trend based on time of year). For example, the user may be associated with a sequence of actions that show that the user accessed the electronic content, scrolled through a first webpage of the electronic content for 10 minutes, and navigated to a second webpage of the electronic content by interacting with a button within the first webpage. In another example, the user may be associated with the month of December due to accessing the electronic content during December, and the manager node 210 may access trends associated with December from the local datastore, such as that more users ten to view the electronic content in December than other months of the year.

At operation 406, manager node 210 generates a predicted metric value indicative of a quality of user experience interacting with the content by applying a trained machine learning model (e.g., prediction model 208, 300) to the obtained set of characteristics. The machine learning model is trained on cluster data representing clusters of users that have interacted with the manager node 210, and each cluster is associated with a one or more shared characteristics of users in the cluster and an average metric value selected by users in the cluster. For example, the clusters may include a cluster of users who enjoy playing video games and live in the Pacific Northwest, and the first cluster may be associated with a detractor NPS because those users find the electronic content to be hard to navigate compared to other electronic content. The predicted metric value can be selected from range of values that users can select from to indicate their satisfaction with their experience interacting with the electronic content. At operation 408, the manager node 200 transmits, to the electronic device 202, an interactive element associated with the predicted metric value. For instance, the manager node may select an interactive element that, upon interaction, navigates the user to a subset of the electronic content related to one of the user's hobbies.

In on example, the manager node 210 employ the process 400 for a user who is viewing a website of a telecommunications network. At operation 402, the manager node 210 may receive an indication that the user has accessed the website via their laptop. At operation 404, the manager node 210 may obtain characteristics describing the user by accessing an account of the user stored by the telecommunications network. The characteristics may include that the user is an engineering student in Southern California, and the manager node 210 may also retrieve actions the user has taken at the website, which includes that the user viewed a webpage describing mobile phones for sale on the website. At operation 406, the manager node 210 generates a predicted metric value for the user by inputting the characteristics and actions to the prediction model 208 (or 300). The prediction model 208 may be trained on clusters of users that interacted with the website, which caused the prediction model 208 to learn how to predict a metric that an engineering student living in Southern California may choose and/or an action that users with those characteristics choose before selecting a higher than average metric value for their cluster. The prediction model 208 may output a predicted metric value of 5. The prediction model 208 may also output the action of “sorting mobile phones from lowest to highest price.” The prediction model 208 may select a button that causes the action upon interaction from the user because the button is associated with the action and is associated with metric values higher than 5. At operation 408, the he manager node 210 transmits the button to the laptop for presentation to the user to guide the user towards sorting the mobile phones for sale.

In some instances, the process includes additional or alternative operations to those shown in FIG. 4. For example, the manager node 210 can obtain experience data for a set of users of the telecommunications system that selected a metric value after interacting with the electronic content. The experience data of each user can include one or more characteristics of the user and the metric value selected by the user after accessing the electronic content. The manager node 210 can apply a clustering algorithm to generate clusters of users from the set of users based on the characteristics such that variance of characteristics between the clusters is minimized and each cluster is associated with a set of shared characteristics of users in the cluster. In some instances, the clustering algorithm is a k-means clustering algorithm. The manager node 210 can label each cluster with the set of shared characteristics of users in the cluster and a combined metric value representative of metric values selected by users in the cluster. The manager node 210 can input the labeled clusters to the machine learning model for training.

In some instances, the manager node compares the predicted metric value to a set of threshold value ranges representing promoter, passive, and detractor NPSs. Responsive to determining that the predicted metric value is out of range of the promoter threshold value range, the manager node 210 can select a corrective interactive element meant to guide the user to an improve experience interacting with the electronic content. Said another way, the manager node 210 can select an interactive element that is likely to increase the user's interaction with the electronic content and lead to a selected metric value higher than the predicted metric value. The corrective interactive element may be associated with an action that taken by users in a cluster associated with a metric within the promoter threshold value range.

### Computer System

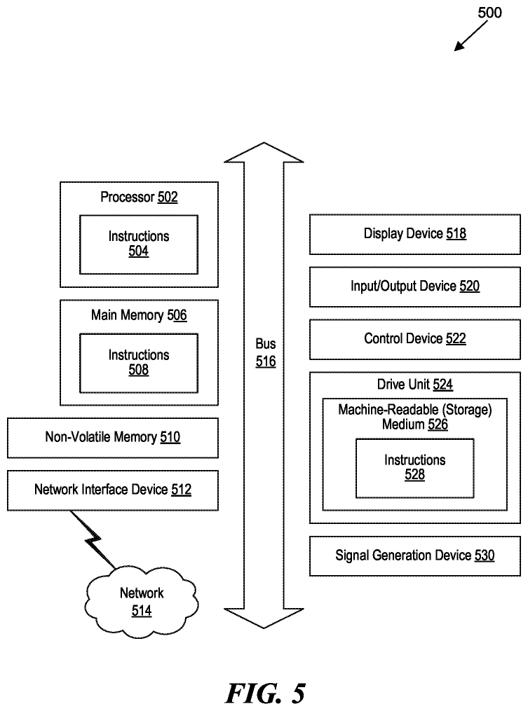

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-readable storage medium, excluding transitory signals and carrying instructions, which, when executed by at least one data processor of a system, cause the system to perform actions comprising:
receiving, from a mobile device, an indication that the mobile device was used to access one or more electronic content associated with a telecommunications network;
obtaining a set of characteristics of a user of the mobile device stored by the telecommunications network;
generating a predicted metric value indicative of a quality of user experience interacting with the one or more electronic content by applying a trained machine learning model to the obtained set of characteristics,
wherein the machine learning model is trained on cluster data representing clusters of users of the telecommunications network, each cluster associated with a one or more shared characteristics of users in the cluster and an average metric value selected by users in the cluster; and
transmitting, to the mobile device, an interactive element associated with the predicted metric value.

2. The computer-readable storage medium of claim 1, wherein the predicted metric value is represented by a range of values that users can select from to indicate their satisfaction with their experience interacting with the electronic content.

3. The computer-readable storage medium of claim 2, wherein the instructions further cause the system to:
obtain experience data for a set of users of the telecommunications system that selected a metric value after interacting with the electronic content, wherein the experience data of each user includes one or more characteristics of the user and the metric value selected by the user;
generating clusters of users from the set of users based on the characteristics such that variance of characteristics between the clusters is minimized, wherein each cluster is associated with a set of shared characteristics of users in the cluster;
labeling, for each cluster, the set of shared characteristics of users in the cluster with a combined metric value representative of metric values selected by users in the cluster; and
inputting the labeled sets of shared characteristics to the machine learning model for training.

4. The computer-readable storage medium of claim 1, wherein the experience data of each user includes a sequence of actions received from the user's mobile device during interaction with the electronic content and generation of clusters is further based on the sequences of actions.

5. The computer-readable storage medium of claim 4, wherein the interactive element is selected by:
comparing the predicted metric value to a threshold value range; and
responsive to determining that the predicted metric value is out of range of the threshold value range, selecting a corrective interactive element, wherein the corrective interactive element is associated with an action that taken by users in a cluster associated with a metric within the threshold value range.

6. The computer-readable storage medium of claim 1, wherein the clusters are generated using a k-means clustering algorithm.

7. The computer-readable storage medium of claim 1, wherein the characteristics include one or more of age, gender, census region, state, ethnicity, income level, employment status, and family status.

8. The computer-readable storage medium of claim 1, wherein the characteristics include one or more of type of the user's mobile device associated with the telecommunications system, handset manufacturer of the user's mobile device, internet speed at the user's mobile device during interaction with the electronic content, internet technology used by the user's mobile device, the user's mobile plan, and the user's data plan.

9. A method comprising:
receiving an indication that an electronic device was used to access one or more electronic content;
obtaining experience data associated with a user of the electronic device;
generating a predicted metric value indicative of a quality of user experience interacting with the one or more electronic content by applying a trained machine learning model to the obtained experience data,
wherein the machine learning model is trained on cluster data representing clusters of users who previously accessed the electronic content, each cluster associated with shared experience data of users in the cluster and a combined metric value selected by users in the cluster; and
transmitting, to the electronic device, an interactive element associated with the predicted metric value.

10. The method of claim 9, wherein the predicted metric value is represented by a range of values that users can select from to indicate their satisfaction with their experience interacting with the electronic content.

11. The method of claim 10, further comprising:
generating the clusters of users who previously accessed the electronic content from based on characteristics and actions described by the experience data such that variance of characteristics and actions between the clusters is minimized, wherein each cluster is associated with a set of shared characteristics and actions associated with users in the cluster;
labeling, for each cluster, the set of shared characteristics and actions associated with users in the cluster with the combined metric value representative of metric values selected by users in the cluster; and
inputting the labeled sets of shared characteristics and actions to the machine learning model for training.

12. The method of claim 9, wherein the experience data further describes a time, date, or season during which the user accessed the electronic content.

13. The method of claim 9, wherein the interactive element is selected by:
comparing the predicted metric value to a threshold value range; and
responsive to determining that the predicted metric value is out of range of the threshold value range, selecting a corrective interactive element, wherein the corrective interactive element is associated with an action that taken by users in a cluster associated with a metric within the threshold value range.

14. The computer-readable storage medium of claim 1, wherein the clusters are generated using a k-means clustering algorithm.

15. A telecommunications system comprising:
at least one hardware processor; and
at least one non-transitory memory storing instructions, which, when executed by the at least one hardware processor, cause the telecommunications system perform actions comprising:
obtaining a set of characteristics of a user of a mobile device associated with a current user session with a website of the telecommunications system;
generating a predicted metric value indicative of a quality of user experience interacting with the website by applying a trained machine learning model to the obtained set of characteristics,
wherein the machine learning model is trained on cluster data representing clusters of users of the telecommunications system, each cluster associated with a one or more shared characteristics of users in the cluster and an average metric value selected by users in the cluster; and
transmitting, to the mobile device, an interactive element associated with the predicted metric value.

16. The telecommunications system of claim 15, wherein the predicted metric value is represented by a range of values that users can select from to indicate their satisfaction with their experience interacting with the website.

17. The telecommunications system of claim 16, wherein the instructions further cause the telecommunications system to:
obtain experience data for a set of users of the telecommunications system that selected a metric value after interacting with the electronic content, wherein the experience data of each user includes one or more characteristics of the user and the metric value selected by the user;
generating clusters of users from the set of users based on the characteristics such that variance of characteristics between the clusters is minimized, wherein each cluster is associated with a set of shared characteristics of users in the cluster;
labeling, for each cluster, the set of shared characteristics of users in the cluster with a combined metric value representative of metric values selected by users in the cluster; and
inputting the labeled sets of shared characteristics to the machine learning model for training.

18. The telecommunications system of claim 15, wherein the experience data of each user includes a sequence of actions received from the user's mobile device during interaction with the website and generation of clusters is further based on the sequences of actions.

19. The telecommunications system of claim 18, wherein the interactive element is selected by:
comparing the predicted metric value to a threshold value range; and
responsive to determining that the predicted metric value is out of range of the threshold value range, selecting a corrective interactive element, wherein the corrective interactive element is associated with an action that taken by users in a cluster associated with a metric within the threshold value range.

20. The telecommunications system of claim 15, wherein the clusters are generated using a k-means clustering algorithm.
